(19) United States
(12) Patent Application Publication
(10) Pub. No.: US 2025/0348778 A1
(43) Pub. Date: Nov. 13, 2025

(54) EVALUATING AND MONITORING ARTIFICIAL INTELLIGENCE MODELS WITH OPTIONAL DELAYED INPUT

(71) Applicant: Google LLC, Mountain View, CA (US)

(72) Inventors: Alan Penichet-Paul, Austin, TX (US); Vladimir Rychev, Rüschlikon (CH)

(21) Appl. No.: 18/660,157

(22) Filed: May 9, 2024

(51) Int. Cl. G06N 20/00

(52) U.S. Cl. CPC G06N 20/00

(57) ABSTRACT

Systems and methods for evaluating and/or monitoring artificial intelligence models based on an accuracy and performance are disclosed. An AI model trained to perform one or more tasks pertaining to one or more media content items of a platform is identified. A set of testing operations is performed, at a first point in time, with respect to the identified AI model. The set of testing operations is associated with testing a performance of an execution environment of the AI model and testing a quality of one or more outputs of the AI model based on a first set of inputs provided to the AI model at the first point in time. A combined quality and performance score for the AI model is determined. A notification indicating the combined quality and performance score for the AI model is sent to the platform.

### TECHNICAL FIELD

Aspects and implementations of the present disclosure relate to evaluating and monitoring artificial intelligence (AI) models with optional delayed input.

### BACKGROUND

AI models are increasingly pivotal in various sectors, including finance, healthcare, automotive, and technology, due to their ability to perform complex tasks such as image recognition, natural language processing, and predictive analytics. The efficacy of these models depends on evaluation techniques to ensure they perform accurately and consistently. As the deployment of AI models grows, the importance of accurate and efficient model evaluation also escalates, ensuring these models perform as expected on real-world data.

AI model evaluation is a critical process that can assess the quality of a model's output and the performance of the infrastructure on which the AI model executes. Quality evaluation can be achieved through metrics such as accuracy, precision, and recall for classification tasks, and mean squared error or mean absolute error for regression tasks. Infrastructure performance evaluation can measure service availability, throughput, and latency of the environment in which the model executes. These two evaluation metrics can be disjointed, which can result in opposition between optimizing for quality and optimizing for infrastructure performance.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In some implementations, a system and method are disclosed evaluating and/or monitoring AI models based on accuracy and performance. In an implementation, a method includes identifying an AI model trained to perform one or more tasks pertaining to one or more media content items of a platform. The method includes performing, at a first point in time, a set of testing operations with respect to the identified AI model. The set of testing operations is associated with testing a performance of an execution environment of the AI model and testing a quality of one or more outputs of the AI model based on a first set of inputs provided to the AI model at the first point in time. The method includes determining a combined quality and performance score for the AI model that reflect the quality of the one or more outputs of the AI model during the performing of the set of testing operations and the performance of the execution environment of the AI model during the performing of the set of testing operations, wherein the performance of the execution environment of the AI model is based on at least one of a latency, a throughput, or a reliability of the execution environment of the AI model. The method includes sending, to the platform, a notification indicating the combined quality and performance score for the AI model.

In some implementations, the method includes performing, at a second point in time, a second set of testing operations with respect to the identified AI model. The second set of testing operations is associated with testing the quality of the one or more outputs of the AI model and testing the performance of the AI model based on a second set of inputs provided to the AI model at the second point in time. The method can further include determining, based on the second set of testing operations, an updated combined quality and performance score for the AI model. The method can further include sending, to the platform, a second notification indicating the updated combined quality and performance score for the AI model. In some implementations, the first set of inputs can include descriptive data of a media content item of the one or more media content items. In some implementations, the second set of inputs can include additional descriptive data of the media content item of the one or more media content items.

In some implementations, the method can include determining whether the combined quality and performance score for the AI model satisfies a criterion. The notification can include an indicator indicating whether the combined quality and performance score for the AI model satisfies the criterion. In some implementations, the method can include determining whether the updated combined quality and performance score for the AI model satisfies a second criterion. The notification can include a second indicator indicating whether the updated combined quality and performance score for the AI model satisfies the second criterion. The criterion can be associated with the first set of inputs provided to the AI model at the first point in time, and the second criterion can be associated with the second set of inputs provided to the AI model at the second point in time.

In some implementations, the method further includes causing the execution of the AI model to pause in response to determining that the combined quality and performance score for the AI model satisfies the criterion.

In some implementations, testing the performance of the execution environment of the AI model can include determining a first number of media content items provided to the platform during a first time period ending at the first point in time, determining a second number of media content items for which the AI model provided at least a subset of the one or more outputs, and performing a comparison of the first number and the second number.

In some implementations, testing the quality of the one or more outputs of the AI model can include determining at least one of an accuracy metric, a precision metric, or a recall metric of the AI model.

An aspect of the disclosure provides a system including a memory device and a processing device communicatively coupled to the memory device. The processing device performs the method as described above.

An aspect of the disclosure provides a computer-readable storage medium (which may be a non-transitory computer-readable storage medium, although the disclosure is not limited to that) stores instructions which, when executed, cause a processing device to perform the method as described above.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with at least one embodiment of the present disclosure.

FIG. 2 depicts an example AI model evaluator, in accordance with at least one embodiment of the present disclosure.

FIG. 3 illustrates an example combined quality and performance evaluation metric for a classification ML model, in accordance with at least one embodiment of the present disclosure.

FIG. 4 is a flow diagram of an example method for evaluating and monitoring an AI model, in accordance with at least one embodiment of the present disclosure.

FIG. 5 is a block diagram illustrating an exemplary computer system, in accordance with at least one embodiment of the present disclosure.

### DETAILED DESCRIPTION

Aspects of the present disclosure relate to evaluating and monitoring an artificial intelligence (AI) model with temporal inputs, based on a combination of the quality of the output of the AI model and the performance of the AI model's execution environment.

Evaluating an AI model can include evaluating the quality of the output of the AI model (e.g., the accuracy of the output(s)) and/or evaluating the performance of the environment in which the AI model executes. An AI model can be an incremental model, receiving optional additional inputs over time. Such an incremental AI model can produce a first output for a first input (or set of inputs), and can update the output as new input (or sets of input) is received. In some instances, developers of the AI model may optimize the model to produce a high quality (e.g., accurate) output when all inputs are available, and evaluating the output of the AI model before all inputs are available may produce a low quality score. For example, evaluating the quality of the output at the first point in time can produce an undesirable score. Thus, in practice, evaluation of AI models with temporal inputs is often performed once all inputs are available.

In contrast, evaluation of the performance of the execution environment of the AI model is often performed soon after the AI model executes (e.g., performs a task and/or produces an output). The evaluation of the performance of the execution environment of the AI model can reflect the functioning of the infrastructure of the system running the AI model, which can include, for example, the server device, the platform, and/or the network on which the AI model is running. The evaluation of the performance of the execution environment may reflect the reliability, availability of the model, throughput, and/or latency of the environment. Since the performance of the environment may not depend on the number of inputs provided to the AI model, but rather reflects whether and when the AI model executes in response to certain triggers (e.g., receiving inputs), the evaluation of the performance can happen at any time (e.g., when the AI model first runs on the first set of inputs). Thus, developers may optimize the environment and/or the AI model based on an evaluation performed as soon as the first set up of inputs are available.

The disparity between the evaluation of the accuracy and quality of the AI model and the evaluation of the performance of the execution environment of the AI model can lead to disjointed optimization techniques. Conventional evaluation of AI models fails to take into consideration the gap between the evaluation of the execution environment of the model and the evaluation of the accuracy of the model. Furthermore, as discussed above, the AI model may be optimized to produce an accurate output when all inputs are available, however may not be evaluated prior to receiving all inputs to avoid an inaccurate or undesirable evaluation score. Waiting for all inputs to be available before evaluating the AI model may result in the execution of an inaccurate or poorly performing model in the period of time before all inputs are available. This period of time may not be inconsequential, and can negatively impact user experience. For example, a model that does not accurately classify a media content item as unsuitable for the general public until six hours after publication may result in an unsuitable content item being published and made public for up to six hours before it is identified as such.

Aspects of the present disclosure address the above-noted and other deficiencies by providing an AI evaluator that evaluates an AI model for accuracy and quality at various points in time, to align with the evaluation of the performance of the execution environment. In some embodiments, the AI model can be a classification machine learning (ML) model that updates or refines its outputs over time, as additional inputs become available. The AI evaluator can be a component (e.g., a software program) hosted by a device (e.g., a server device) to evaluate the AI model for both accuracy and performance of the execution environment at various points in time, to align the optimizations of both the metrics.

In some embodiments, the AI model can be a classification machine learning (ML) model that outputs a first classification when a first set of inputs is received, and refines the classification as more input data is received. For example, the AI model can perform one or more classification tasks of a media content item. For example, the AI model can classify a media content item of a content sharing platform as suitable for the general population or unsuitable for the general population. A first set of inputs can be available at a first time period (e.g., five minutes after publication of the media content item by the content sharing platform). The first set of inputs can include title, duration, resolution, bitrate, etc. The AI model can output a first classification based on the first set of inputs. Over time, more details about the media content item can become available, such as captions, a transcript of the audio, user reaction data (e.g., whether it has been flagged, shared, liked, etc.), and/or other additional descriptive data. The AI model can refine (or update) the first classification in response to receiving, as input, the additional data that has become available.

In some embodiments, the AI evaluator can determine expected quality and performance metrics for the AI model by running testing operations during development and/or installation of the AI model. The quality of the AI model can reflect the quality of the output of the model. The testing operations to measure the expected quality can include, for example, evaluating the accuracy of the, precision, recall, and/or other strategies or metrics for assessing the quality of the AI model. The expected quality of the AI model can change according to the inputs that are provided to the AI model. Thus, the AI evaluator can determine a first expected quality metric that corresponds to a first set of inputs provided to the AI model at a first time period, and additional expected quality metrics that correspond to additional sets of inputs provided to the AI model at subsequent time periods. Thus, the AI evaluator can map the inputs available at various times to the expected quality of the model.

The performance of the execution environment of the AI model can reflect, for example, the throughput of the model, the latency of the model, and/or the reliability of the model. The throughput can reflect the number of tasks performed by the AI model within a time period (e.g., the number of media items for which the model has produced a classification). The latency of the model can reflect a time period between receiving the input and producing an output by the AI model. The reliability of the model can reflect a number of error notifications or warning messages received during execution of the AI model within a time period. The testing operations can include, for example, determining a threshold number of tasks performed by the AI model within a certain time period to implement an AI model that functions effectively. For example, the threshold number of tasks can reflect the number of tasks needed to ensure that the throughput of the AI model satisfies a user experience criterion. In some embodiments, the AI evaluator can store the expected quality and/or performance metrics.

In some embodiments, the AI evaluator can monitor the AI model during runtime. The AI evaluator can monitor the AI model for both quality and performance of the execution environment. The AI evaluator can perform similar testing operations to evaluate the quality of the output of the AI model, and can compare the measured quality to the expected quality. That is, the testing operations can include determining the accuracy, precision, recall, and/or other strategies or metrics for assessing the quality of the AI model. If the monitored quality of the AI model falls below the expected quality, the AI evaluator can notify the platform of the comparison results, and/or can pause execution of the AI model. The AI evaluator can compare the measured quality of the AI model at various points in time to the expected quality corresponding to the inputs available at the respective points in time.

The AI evaluator can also determine the runtime performance of the execution environment of the AI model, e.g., by determining the throughput of the model, the latency of the model, and/or the reliability of the model. The AI evaluator can compare the determined runtime evaluation of the AI model to the stored expected values. If the performance of the execution environment of the AI model falls below the expected value, the AI evaluator can notify the platform, and/or pause execution of the AI model.

In some embodiments, the AI evaluator can generate a combined quality and performance metric that reflects both the quality of the output(s) of the AI model, as well as the performance of the execution environment of the AI model. In some embodiments, the AI evaluator can combine the quality score and performance score, e.g., by adding them together, or by determining an average of the scores. In some embodiments, the average can be weighted (e.g., the average can place more weight on the performance score at the first time period, and more weight on the quality score at the second time period).

Aspects of the present disclosure provide a number of technical advantages including, for example, a mechanism to incrementally evaluate and/or monitor, for both accuracy and execution performance, an AI model that receives inputs over time. By evaluating and/or monitoring the AI model incrementally, AI models that fall below performance and/or accuracy expectations can be identified and addressed early on in development or execution, thereby reducing the overall computing resources and time spent on developing or executing a low-performing model.

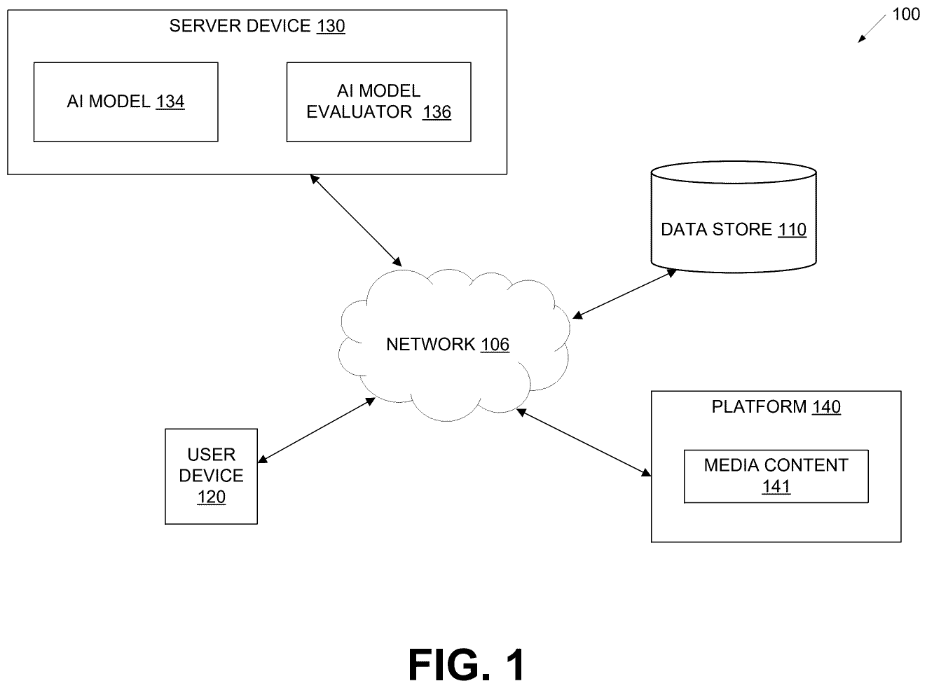

FIG. 1 illustrates an example system architecture 100, in accordance with at least one embodiment of the present disclosure. The system architecture 100 includes one or more user device(s) 120, a platform 140, a data store 110, and/or a server device 130, each connected to a network 106. Network 106 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

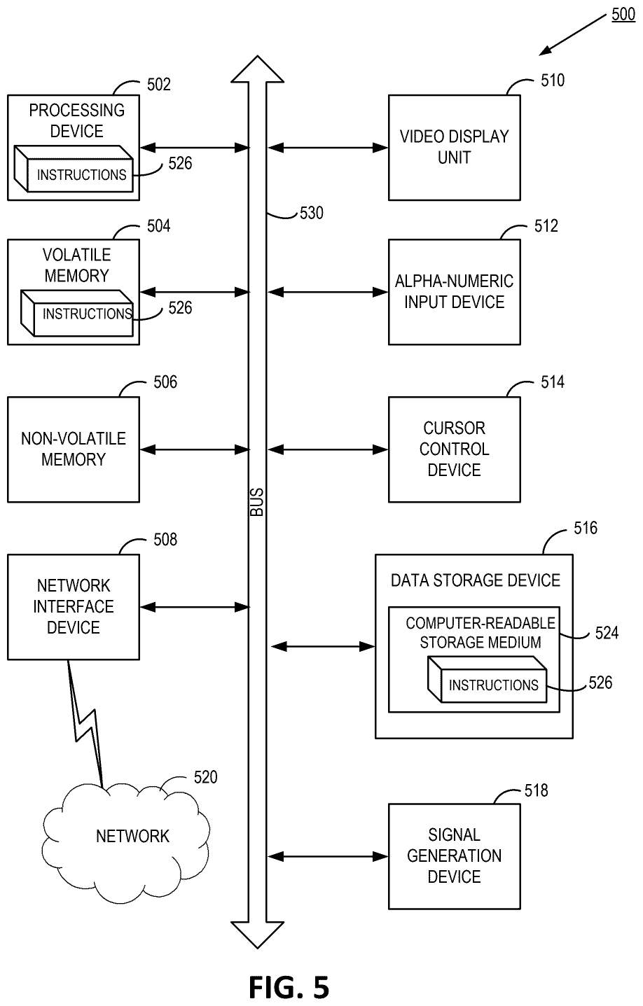

User device(s) 120 can include computing devices such as personal computers (PCs), laptops, mobile computing devices, mobile phones, smart phones, tablet computers, netbook computers, network-connected televisions, digital assistants, Internet of Things (IoT) devices, or any other computing devices capable of communicating with platform 140. FIG. 5 illustrates an example architecture of a user device 120. In some embodiments, user device 120 can also be referred to as a “client device.”

In implementations of the disclosure, a “user” may be represented as a single individual. However, other implementations of the disclosure encompass a “user” being an entity controlled by a set of users and/or an automated source. For example, a set of individual users federated as a community in a social network may be considered a “user”. In another example, an automated consumer may be an automated ingestion pipeline, such as a channel, of the platform 140.

In some embodiments, user device 120 can include a content viewer. In some implementations, a content viewer may be an application that provides a user interface (UI) for users to view or upload content, such as images, video items, podcast episodes, web pages, documents, etc. For example, the content viewer may be a web browser that can access, retrieve, present, and/or navigate content (e.g., web pages such as Hyper Text Markup Language (HTML) pages, digital media items, etc.) served by a web server. The content viewer may render, display, and/or present the content to a user. The content viewer may also include an embedded media player (e.g., a Flash® player or an HTML5 player) that is embedded in a web page (e.g., a web page that may provide information about a product sold by an online merchant). In another example, the content viewer may be a standalone application (e.g., a mobile application or app) that allows users to view digital media items (e.g., digital video items, digital podcast episodes, digital images, electronic books, etc.).

According to aspects of the disclosure, the content viewer may be a content sharing platform application for users to record, edit, and/or upload content for sharing on platform 140. As such, the content viewers may be provided to the user device 120 by platform 140. For example, the content viewers may be embedded media players that are embedded in web pages provided by the platform 140.

Platform 140 can be a content sharing platform that includes media content 141. Media content 141 can include one or more media items. In some embodiments, media content 141 can be digital content chosen by a user (e.g., user of user device 120), digital content made available by a user, digital content uploaded by a user, digital content chosen by a content provider, digital content chosen by a broadcaster, etc. A media item of media content 141 may be consumed via the Internet or via a mobile device application, such as a content viewer of a user device 120. A media item of media content 141 may be requested for presentation to the user by the user of the platform 140. As used herein, “media,” “media item,” “online media item,” “digital media,” “digital media item,” “content,” and “content item” can include an electronic file that can be executed or loaded using software, firmware, or hardware configured to present the digital media item to an entity. In one implementation, the platform 140 may store the media items of media content 141 using the data store 110. In another implementation, the platform 140 may store media items of media content 141 or fingerprints as electronic files in one or more formats using data store 110. The media items of media content 141 may be provided to the user, wherein the provision of the media items of media content 141 may include allowing access to the media items of media content 141, transmitting the media items of media content 141, and/or presenting or permitting presentation of the media items of media content 141.

In some implementations, a media item of media content 141 may be a video item. A video item is a set of sequential video frames (e.g., image frames) representing a scene in motion. For example, a series of sequential video frames may be captured continuously or later reconstructed to produce animation. Video items may be provided in various formats including, but not limited to, analog, digital, two-dimensional and three-dimensional video. Further, video items may include movies, video clips or any set of animated images to be displayed in sequence. In addition, a video item may be stored as a video file that includes a video component and an audio component. The video component may refer to video data in a video coding format or image coding format (e.g., H.264 (MPEG-4 AVC), H.264 MPEG-4 Part 2, Graphic Interchange Format (GIF), WebP, etc.). The audio component may refer to audio data in an audio coding format (e.g., advanced audio coding (AAC), MP3, etc.). It may be noted GIF may be saved as an image file (e.g., .gif file) or saved as a series of images into an animated GIF (e.g., GIF89a format). It may be noted that H.264 may be a video coding format that is block-oriented motion-compensation-based video compression standard for recording, compression, or distribution of video content, for example. In some implementations, a media item of media content 141 may be an audio file, such as a podcast episode or an audiobook. In some implementations, a media item of media content 141 can be another form of media, such as text, images, and/or a combination of media types.

In some embodiments, data store 110 is a persistent storage that is capable of storing media items of media content 141 (or a subset of media content 141), characteristics of the media item(s) of media content 141, logs corresponding to platform 140 (e.g., the upload and publication of media item(s) of media content 141), and/or evaluation metrics of AI models trained to perform tasks with respect to media item(s) of media content 141, as well as data structures to tag, organize, and index the stored data. Data store 110 may be hosted by one or more storage devices, such as main memory, magnetic or optical storage based disks, tapes or hard drives, NAS, SAN, and so forth. In some implementations, data store 110 may be a network-attached file server, while in other embodiments data store 110 may be some other type of persistent storage such as an object-oriented database, a relational database, and so forth, that may be hosted by server device(s) 130, platform 140, and/or user device(s) 120. In some embodiments, data store 110 may be hosted by or one or more different machines coupled to the server device 130, platform 140, and/or user device 120.

In some embodiments, platform 140 and/or server device 130 can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to provide a user with access to media content 141 and/or provide the media content 141 to the user (e.g., of user device 120). For example, platform 140 may allow a user to consume, upload, search for, approve of (“like”), disapprove of (“dislike”), or comment on media items of media content 141. Content sharing platform 140 may also include a website (e.g., a webpage) or application back-end software that may be used to provide a user with access to the media content 141. In some implementations, server device 130 or any of its components can be combined with platform 140. FIG. 5 illustrates an example architecture of a server device 130 and/or a platform 140.

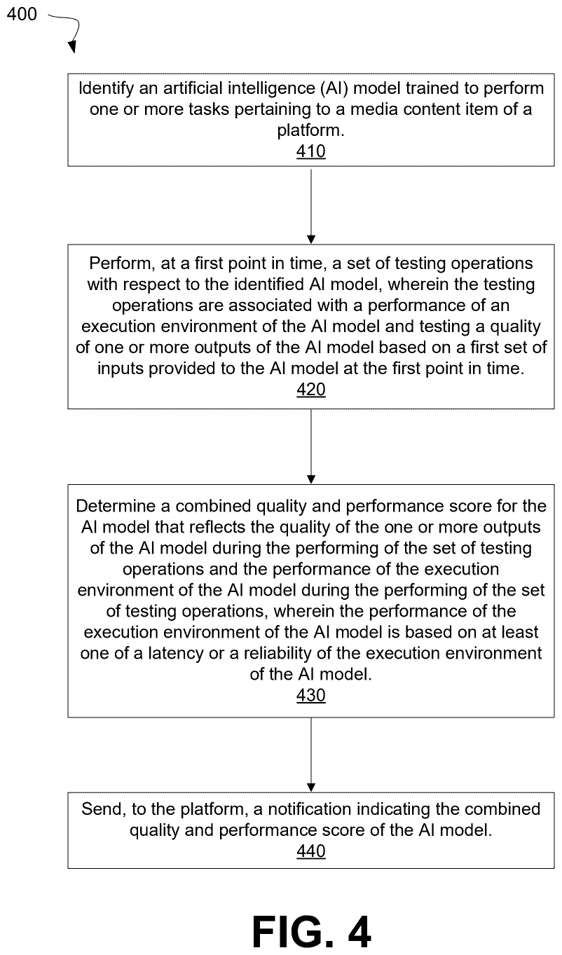

Server device 130 can include an AI model 134 and/or an AI model evaluator 136. AI model 134 can be any kind of AI model, such as a deep learning model, a probabilistic model, a hybrid model, a classification model, or any other kind of AI model. In some embodiments, AI model 134 can be trained to perform tasks pertaining to media content 141. In some embodiments, AI model 134 can be, for example, a classification machine learning (ML) model. The classification ML model can be trained to assign input data into predefined categories or classes based on features. The classification ML model can be a supervised ML model that is trained on a set of labeled data. In some embodiments, the classification ML model can produce an output (or classification) at a first point in time, in response to receiving a first set of input values, and then refine or update the output as more input values are received. In some implementations, the AI model 134 can perform tasks pertaining to a media item of media content 141. The tasks can pertain to, for example, trust and safety classifications. The tasks can include, for example, classifying the media item as suitable for all audiences, flagging the media item as a particular type of content, and/or other such classification. The tasks can pertain to any other type of classification of the media items of media content 141. The tasks performed by AI model 134 are further described with respect to FIG. 4. In some implementations, the AI model 134 can perform tasks pertaining to other sources of data. For example, the AI model 134 can be an incremental classification machine learning model that classifies medical data (e.g., physician notes, images, etc.) by diagnosis.

In some embodiments, AI model evaluator 136 can evaluate and/or monitor the execution of AI model 134. The AI model evaluator 136 can evaluate the AI model 134 to reflect the performance of the execution environment of the AI model 134, as well as the quality of the output(s) of the AI model 134 over time. The execution environment of the AI model 134 can include, for example, the server device 130, the network 106, the platform 140, the data store 110, and/or the user device 120. Evaluation of the performance of the execution environment can include determining the reliability, throughput, and/or latency of the execution environment, and/or the throughput of the AI model executing in the execution environment. As an example, to test the performance of the execution environment of the AI model 134, the AI model evaluator 136 can identify a number of media items of media content 141 that were made available in a first time window, and the number of media items of media content 141 for which the AI model 134 produced an output within a certain time period of being made available. A media item can be made available when it is uploaded by a user, or when it is published by platform 140. Publishing a media item can include making it available to the public (e.g., for viewing by user device 120). The ratio of the number of media items made available to the number of media items for which the AI model 134 produced an output can represent the throughput performance of the execution environment. As another example, the AI model evaluator 136 can monitor the amount of time that the AI model 134 takes before producing an output. This measurement can reflect the latency of the environment. As another example, the AI model evaluator 136 can monitor the errors or warnings generated by the execution environment of the AI model 134 during execution of the model, which can reflect the reliability of the execution environment of the AI model 134. The AI model evaluator 136 can compare the monitored performance of the execution environment to stored threshold values, to determine whether the execution AI model 134 is satisfactory. If the monitored performance metrics of the execution environment of the AI model 134 fall below the threshold, the AI model evaluator 136 can notify the platform 140 and/or pause execution of the AI model 134. For example, if the throughput falls below the threshold value, the AI model evaluator 136 can determine that there is a backlog in the system, and can notify the platform 140. In some implementations, the platform 140 may then redirect classification requests to another AI model.

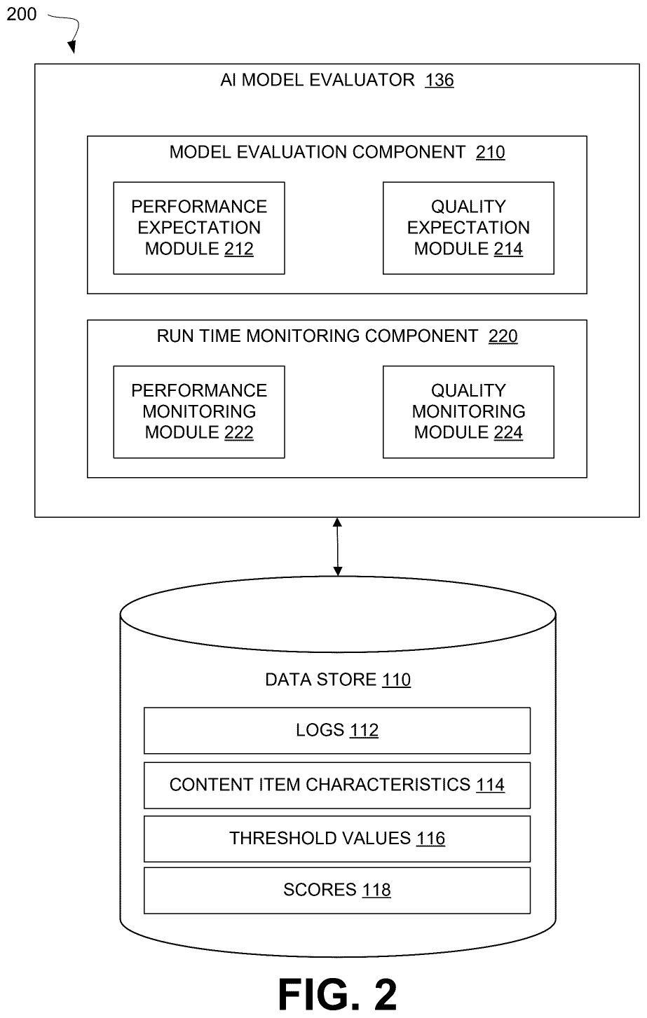

In some embodiments, AI model evaluator 136 can also evaluate the AI model 134 to reflect the quality of the output(s) provided by the AI model 134. The quality of the output can reflect the accuracy of the output, for example. AI model evaluator 136 can use one or more metrics to evaluate the quality of the output, such as an accuracy metric, a precision metric, a recall metric, and/or a combination of metrics. For example, the AI model evaluator 136 can evaluate the output of the AI model using precision and recall metrics. The AI model evaluator 136 is further described with respect to FIG. 2. In some embodiments, the AI model evaluator 136 (or a portion of the AI model evaluator 136) can be a part of AI model 134. In some embodiments, the AI model evaluator 136 can receive evaluation metrics from AI model 134, determined during the evaluation phase of training the AI model 134.

In some embodiments, the AI model evaluator 136 can determine an expected quality of outputs of the AI model 134 at various points in time correlating to various inputs being available, as well as an expected performance of the execution environment of the AI model 134 at various points in time. The AI model evaluator 136 can store the expected quality of outputs and the expected performance of the execution environment in data store 110. Once determined, the AI model evaluator 136 can monitor the execution of the AI model 134. The AI model evaluator 136 can determine performance and/or quality metrics of the AI model 134 during runtime, and compare the metrics to the stored expected values in data store 110. The AI model evaluator 136 can send a notification to platform 140 indicating a result of the comparison. For example, the AI model evaluator 136 can determine that the performance of the execution environment of the AI model 134 and/or the quality of the output(s) of the AI model is less than the expected metric values, the AI model evaluator 136 can send a notification to the platform 140. In some implementations, the AI model evaluator 136 and/or the platform 140 can pause execution of the AI model 134 in response to determining that the quality and/or performance evaluations are below a threshold value.

In situations in which the system discussed here collects personal information about users, or may make use of personal information, the users may be provided with an opportunity to control whether server device 130 and/or platform 140 collects user information (e.g., personal information about the user, information about a user's location, a user's preferences, and/or any other personal information), or to control whether and/or how to receive content from the server device 130 that may be more relevant to the user. In addition, certain data may be treated in one or more ways before it is stored or used, so that personally identifiable information is removed. Thus, the user may have control over how information is collected about the user and used by server device 130, platform 140, and/or user device 120.

FIG. 2 depicts an example AI model evaluation system 200, in accordance with at least one embodiment of the present disclosure. The AI evaluation system 200 can include an AI model evaluator 136 and one or more data stores 110. The AI model evaluator 136 can access the data store 110, e.g., via network 106 of FIG. 1. The AI model evaluator 136 can include a model evaluation component 210 and a runtime monitoring component 220.

Data store 110 can store logs 112, content item characteristics 114, threshold values 116, and/or scores 118. Logs 112 can include records that store data about events that occurred within the system 100. The events for which data is stored in logs 112 can include receiving content item characteristic data for a media item of media content 141 of FIG. 1, providing data as input to AI model 134 of FIG. 1, receiving an output from AI model 134, and other events pertaining to the execution of AI model 134. Logs 112 can store the event that occurred (e.g., an event type) along with a timestamp of when the event occurred. Logs 122 can optionally also include a description of the event, the source of the event, etc. The source of the event can be, for example, which AI model produced the output if multiple AI models are running, or from which platform the content item characteristic data is received.

Content item characteristics 114 can store the information pertaining to content items in media content 141 of FIG. 1 that were processed by AI model 134. Content item characteristics 114 can include, for example, a media item identification number, a title, an identification of the user that provided the media item, a duration of the media item, resolution of the media item, bitrate, a transcript of the audio of the media item (or a reference to a transcript of the audio), captions, user reactions to the media item on platform 140 (e.g., number of times users have shared the media item, number of users that have liked (or disliked) the media item, etc.), and/or any other descriptive data of the media item. Content item characteristics 114 can be received at various times. For example, a user of user device 120 can upload a video to platform 140. Shortly after platform 140 publishes the video (e.g., five minutes after publication), platform 140 can provide a first set of characteristic data for the video. The first set of characteristic data can include, for example, the title, the identification of the user that provided the media item, the duration of the media item, resolution of the media item, and/or the bitrate. At a second time period (e.g., six hours after platform 140 publishes the video), platform 140 can provide a second set of characteristic data for the video. The second set of characteristics can be data that is available within a longer time period after the media item has been published. The second set of characteristic data can include, for example, the transcript of the audio, captions, user reactions to the media item (e.g., a number of users that have liked and/or shared the media item on the platform), and/or any other additional data describing the media item.

Threshold values 116 can store expected quality and/or performance scores for an AI model 134 that is being monitored and/or evaluated by AI model evaluator 136. Threshold values 116 can map the expected quality and/or performance scores for the AI model 134 to the inputs provided to the AI model 134 to generate the corresponding expected quality and/or performance scores. Scores 118 can store evaluation scores generated by runtime monitoring component 220. In some embodiments, runtime monitoring component 220 can store a history of evaluation scores of an AI model 134. Runtime monitoring component 220 can analyze the history of evaluation scores to determine if the performance and/or quality of an AI model 134 is improving or decreasing over time.

Model evaluation component 210 can evaluate an AI model (e.g., AI model 134 of FIG. 1) during development of the AI model and installation of the AI model in the system 100. Model evaluation component 210 can include a performance expectation module 212, and a quality expectation module 214. Performance expectation module 212 can perform testing operations pertaining to the execution environment of the AI model. Performance expectation module 212 can perform the testing operations during development of the AI model and/or during installation of the AI model. The testing operations can include, for example, determining a minimum number of media items that the AI model can process within a certain time period to reflect the throughput of the AI model. The testing operations can include, for example, determining a minimum number of errors or warning messages generated by the execution of the AI model within a certain time period, to reflect the reliability of the AI model. The testing operations can include, for example, determining a maximum amount of time spent on producing an output, to reflect the latency of the AI model running in the execution environment.

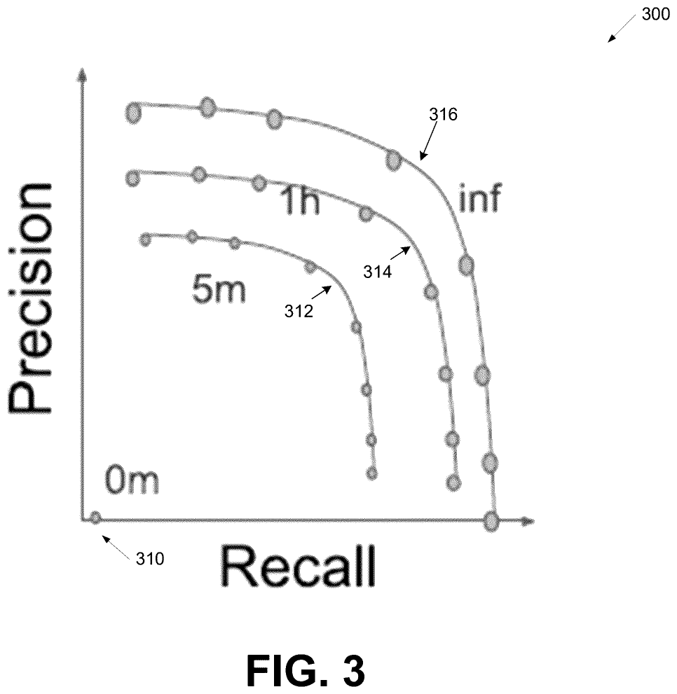

Quality expectation module 214 can determine the expected quality of the model. In some embodiments, quality expectation module 214 can perform a number of testing operations with respect to the AI model 134. In some embodiments, the quality expectation module 214 can evaluate the AI model 134 during training of the model. For a classification model, the testing operations can include, for example, measuring the percentage of correct predictions, measuring the accuracy of positive predictions, measuring the ability to find all positive instances, determining a balance between the accuracy of positive predictions and the all positive instances, and/or measuring the model's ability to discriminate between classes. Quality expectation module 214 can analyze the logs 112 and perform testing operations for a variety of sets of input provided to the AI model at various points in time. Thus, the quality expectation module 214 can map the set of inputs provided to the AI model with expected quality of the outputs of the AI model. An example of the mapping of the inputs of the expected quality for a classification ML model is described with respect to FIG. 3.

Runtime monitoring component 220 can monitor an AI model (e.g., AI model 134 of FIG. 1) during runtime of the AI model. The runtime monitoring component 220 can include a performance monitoring module 222 and/or a quality monitoring module 224. The performance monitoring module 222 can measure the performance of the execution environment of the AI model during runtime, and can store the measured performance in scores 118. The performance monitoring module 222 can perform the same testing operations as performance expectation module 212 to measure the performance of the execution environment of AI model 134. The quality monitoring module 224 can measure the quality of the outputs of AI model 134 during execution of the model. The quality monitoring module 224 can perform the same testing operations as quality expectation module 214 to measure the quality of the AI model 134, and can store the measured quality metrics in scores 118.

In some embodiments, the model evaluation component 210 can combine the expected performance and quality scores to generate a combined expected performance and quality score, and the runtime monitoring component 220 can combine the measured performance and quality scores at various time periods during runtime (e.g., to correspond with the various sets of inputs) to generate a combined performance and quality score. The scores can be combined by adding them, or by determining an average of the scores. The average can be weighted. For example, the performance score can be weighted more heavily at the first time period, and the quality score can be weighted more heavily at the second time period.

FIG. 3 illustrates an example graph 300 showing a combined quality and performance evaluation metric for an AI model, in accordance with at least one embodiment of the present disclosure. In some embodiments, the combined quality and performance score for the AI model can be based on precision and recall metrics for the AI model. In some embodiments, the combined quality and performance score for the AI model can be based on other metrics, such as an accuracy metric. In some embodiments, the combined quality and performance score for the AI model can be based on a combination of these and/or other metrics. Evaluation metrics, such as accuracy, prevision, and recall, analyze the four possible outcomes of an AI classification model: true positives, false positives, false negatives, and true negatives. A true positive is an outcome where the model correctly predicted the positive class. A true negative is an outcome where the model correctly predicted the negative class. A false positive is an outcome where the model incorrectly predicted the positive class. A false negative is an outcome where the model incorrectly predicted the negative class. The accuracy metric can be described as the fraction of correct outcomes of the AI model. Accuracy can be measured by dividing the number of correct predictions by the total number of predictions. The precision metric indicates the proportion of positive identifications that were actually correct, and can be described as the ratio of true positive outputs of the AI model to the sum of true positive and false positive outputs of the AI model. A model that has no false positives has a precision of 1.0. The recall metric indicates the proportion of actual positives that were identified correctly, and can be described as the ratio of true positive outputs of the AI model to the sum of true positive and false negative outputs of the AI model. A model that has no false negatives has a recall of 1.0.

An evaluation of a classification model can include examining both the precision and recall together. One way to examine both precision and recall together is by determining the area under the curve of the graph 300, in which the precision is shown on the y-axis and the recall is shown on the x-axis. The curves 310-316 illustrate the precision and recall metrics measured at different points in time. For example, curve 310 illustrates the precision and recall metrics measured at time zero (e.g., when no inputs are received), curve 312 illustrates the precision and recall metrics measured at time 5 minutes (e.g., when a first set of inputs is received), curve 314 illustrates the precision and recall metrics measured at time 1 hour (e.g., when a second set of inputs is received), and curve 316 illustrates the precision and recall metrics measured at time x. Time x can represent the time at which the AI model has received all inputs.

The area under the curve provides an aggregate measure of quality across all possible classification thresholds. One way of interpreting the area under the curve is as the probability that the AI model ranks a random positive example more highly than a random negative example. The area under the curve values range from 0 to 1. A model that has 100% incorrect predictions as an area under the curve value of 0.0. A model that has 100% correct prediction has an area under the curve value of 1.0.

As illustrated in FIG. 3, the probability that the AI model ranks a random positive higher than a random negative increases over time, as more inputs become available. That is, the quality of the outputs of the AI model increases as more inputs become available. During training of the AI model 134, the AI model 134 can finetune the hyperparameters of the model to find the configuration to produce an accurate output for the set of inputs available. The AI model evaluator 136 can analyze the logs 112 to identify which inputs were provided to the AI model 134 to produce which output(s). Thus, the AI model evaluator 136 can map the inputs available at various points in time to the expected quality. Thus, at a first time period (e.g., five minutes illustrated by curve 312), the AI model evaluator 136 can determine that the expected quality of the outputs of AI model 134 that processes the first set of inputs be at least the area under curve 312. At a second time period (e.g., 1 hour illustrated by curve 314), the AI model evaluator 136 can determine that the expected quality of the outputs of AI model 134 that processes the second set of inputs is at least the area under curve 314. At another second time period (e.g., illustrated by curve 316), the AI model evaluator 136 can determine that the expected quality of the outputs of AI model 134 that processes the complete set of inputs is at least the area under curve 316.

In some embodiments, the time periods corresponding to each curve can be associated with an expected performance metric of the execution environment of the AI model 134. Thus, the AI model evaluator 136 can determine an expected performance metric of the execution of AI model 134 at a first time period (e.g., 5 minutes corresponding to curve 312), at a second time period (e.g., 1 hour corresponding to curve 314), etc., through a time period corresponding to curve 316.

FIG. 4 is a flow diagram of an example method 400 for evaluating and/or monitoring an AI model based on quality of the outputs and performance of the execution environment, according to at least one embodiment. Method 400 can be performed by processing logic that can include hardware (circuitry, dedicated logic, etc.), software (e.g., instructions run on a processing device), or a combination thereof. In at least one implementation, some or all of the operations of method 400 can be performed by one or more components of server devices 130 of FIG. 1. In other implementations, some or all of the operations of method 400 can be performed by one or more components of user device 120, and/or platform 140 of FIG. 1.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts can be required to implement the methods in accordance with the disclosed subject matter. In addition, those skilled in the art will understand and appreciate that the methods could alternatively be represented as a series of interrelated states, e.g., via a state diagram. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-related device or storage media.

At block 410, processing logic identifies an AI model (e.g., AI model 134 of FIG. 1) trained to perform one or more tasks pertaining to one or more media content items of a platform (e.g., content items of media content 141 of platform 140 of FIG. 1). The tasks performed by the AI model can include, for example, determining whether the media violates the platform's (e.g., platform 140 of FIG. 1) community guidelines, policies, and/or terms of use; assessing whether a media content item was produced by a generative AI model, in particular whether a media content item can be perceived as a misleading deepfake; determining whether a media content item is a full or partial transformed copy of copyrighted or illegal material; determining whether a media content item contains particular types of violative content (e.g., hate speech, medical misinformation, animal abuse, graphic violence, incitement to violence, violent extremism, sexual content, and/or nudity); determining which language is predominantly spoken in the audio track of a media content item, and/or extract the captions of that speech; determining a rating of media content item (e.g., according to motion picture association film rating system); identifying misleading and/or scam content (e.g., videos promoting cryptocurrency Ponzi schemes); addressing the quality of a media content item from the perspective of whether the platform may recommend the media content item to users, and whether users may enjoy or not enjoy the content; assessing whether a media content item satisfies a predefined category (e.g., music, or shortform video); clustering a media content item with similar preexisting content items; assessing whether a media content item contains one or more categories of entities (e.g., firearms); identifying a topic and/or type of content (e.g., sports/hockey, standup comedy); extracting general purpose media understanding features that can be stored and subsequently used by other classifiers; estimating the probability that a media content item satisfies a personalized “watch next” recommendation for a particular subset of users; or any other tasks pertaining to one or more media content items.

At block 420, processing logic performs, at a first point in time, a set of testing operations with respect to the identified AI model. The set of testing operations can be associated with testing the performance of the execution environment of the AI model and testing a quality of one or more outputs of the AI model based on a first set of inputs provided to the AI model at the first point in time.

In some implementations, testing the performance of the execution environment of the AI model can include determining a first number of media content items provided to the platform during a first time period ending at the first point in time, and determining a second number of media content items for which the AI model provided at least a subset of the one or more outputs. The processing logic can then compare the first number and the second number. The comparison can reflect the throughput, latency, and/or reliability of the AI model.

In some implementations, testing the quality of the one or more outputs of the AI model can include determining at least one of an accuracy metric, a precision metric, a recall metric, or an area under a curve metric, as described with respect to FIG. 3.

At block 430, processing logic determines a combined quality and performance score for the AI model that reflects the quality of the one or more outputs of the AI model during execution of the set of testing operations and the performance of the execution environment of the AI model during execution of the set of testing operations. The performance of the execution environment of the AI model is based on at least one of a latency, throughput, or a reliability of the execution environment of the AI model.

At block 440, processing logic sends, to the platform, a notification indicating the combined quality and performance score for the AI model. In some implementations, the processing logic determines whether the combined quality and performance score for the AI model satisfies a criterion. The notification sent to the platform can include an indicator indicating whether the combined quality and performance score for the AI model satisfies the criterion. The criterion can correspond to an expected combined quality and performance score for the AI model (e.g., the criterion can correspond to threshold values 116 of FIG. 2). The expected combined quality and performance score can be determined during development, training, and/or installation of the AI model. In some implementations, responsive to determining that the combined quality and performance score for the AI model satisfies the criterion, processing logic can cause the AI model to pause.

In some implementations, processing logic performs, at a second point in time, a second set of testing operations with respect to the identified AI model. The second set of testing operations can be associated with testing the quality of the one or more outputs of the AI model and testing the performance of the execution environment of the AI model based on a second set of inputs provided to the AI model at the second point in time. Processing logic can determine, based on the second set of testing operations, an updated combined quality and performance score for the AI model. Processing logic can send, to the platform, a second notification indicating the updated combined quality and performance score for the AI model. The first set of inputs and/or the second set of inputs can include characteristic data of a content media item of the one or more media content items. For example, the first set of inputs can include characteristic data of a media content item provided to the AI model at the first point in time, and the second set of inputs can include additional characteristic data of the media content item provided to the AI model at the second point in time.

FIG. 5 is a block diagram illustrating an exemplary computer system 500, in accordance with at least one embodiment of the present disclosure. The computer system 500 can correspond to server device 130, platform 140, and/or user device 120 in FIG. 1. The machine can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processing device (processor) 502, a main memory 504 (e.g., volatile memory, read-only memory (ROM), flash memory, dynamic random access memory (DRAM) such as synchronous DRAM (SDRAM), double data rate (DDR SDRAM), or DRAM (RDRAM), etc.), a static memory 506 (e.g., non-volatile memory, flash memory, static random access memory (SRAM), etc.), and a data storage device 516, which communicate with each other via a bus 530.

Processor (processing device) 502 represents one or more general-purpose processing devices such as a microprocessor, central processing unit, or the like. More particularly, the processor 502 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 502 can also be one or more special-purpose processing devices such as an application specific integrated circuit (ASIC), a field programmable gate array (FPGA), a digital signal processor (DSP), network processor, or the like. The processor 502 is configured to execute instructions 526 (e.g., for evaluating and/or monitoring an AI model) for performing the operations discussed herein.

The computer system 500 can further include a network interface device 508. The computer system 500 also can include a video display unit 510 (e.g., a liquid crystal display (LCD) or a cathode ray tube (CRT)), an input device 512 (e.g., a keyboard, and alphanumeric keyboard, a motion sensing input device, touch screen), a cursor control device 514 (e.g., a mouse), and a signal generation device 518 (e.g., a speaker).

The data storage device 516 can include a non-transitory machine-readable storage medium 524 (also computer-readable storage medium) on which is stored one or more sets of instructions 526 (e.g., for evaluating and/or monitoring an AI model) embodying any one or more of the methodologies or functions described herein. The instructions can also reside, completely or at least partially, within the main memory 504 and/or within the processor 502 during execution thereof by the computer system 500, the main memory 504 and the processor 502 also constituting machine-readable storage media. The instructions can further be transmitted or received over a network 520 via the network interface device 508.

In one implementation, the instructions 526 include instructions for evaluating and/or monitoring AI models based on quality and performance. While the computer-readable storage medium 524 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics may be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user may opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
identifying an artificial intelligence (AI) model trained to perform one or more tasks pertaining to one or more media content items of a platform;
performing, at a first point in time, a set of testing operations with respect to the identified AI model, wherein the set of testing operations is associated with testing a performance of an execution environment of the AI model and testing a quality of one or more outputs of the AI model based on a first set of inputs provided to the AI model at the first point in time;
determining a combined quality and performance score for the AI model that reflects the quality of the one or more outputs of the AI model during the performing of the set of testing operations and the performance of the execution environment of the AI model during the performing of the set of testing operations, wherein the performance of the execution environment of the AI model is based on at least one of a latency, a throughput, or a reliability of the execution environment of the AI model; and
sending, to the platform, a notification indicating the combined quality and performance score for the AI model.

2. The method of claim 1, further comprising:
performing, at a second point in time, a second set of testing operations with respect to the identified AI model, wherein the second set of testing operations is associated with testing the quality of the one or more outputs of the AI model and testing the performance of the execution environment of the AI model based on a second set of inputs provided to the AI model at the second point in time;
determining, based on the second set of testing operations, an updated combined quality and performance score for the AI model; and
sending, to the platform, a second notification indicating the updated combined quality and performance score for the AI model.

3. The method of claim 1, further comprising:
determining whether the combined quality and performance score for the AI model satisfies a criterion, wherein the notification comprises an indicator indicating whether the combined quality and performance score for the AI model satisfies the criterion.

4. The method of claim 3, further comprising:
responsive to determining that the combined quality and performance score for the AI model satisfies the criterion, causing execution of the AI model to pause.

5. The method of claim 3, wherein the criterion corresponds to the first set of inputs provided to the AI model at the first point in time.

6. The method of claim 1, wherein testing the performance of the execution environment of the AI model comprises:
determining a first number of media content items provided to the platform during a first time period ending at the first point in time;
determining a second number of media content items for which the AI model provided at least a subset of the one or more outputs; and
performing a comparison of the first number and the second number.

7. The method of claim 1, wherein testing the quality of the one or more outputs of the AI model comprises determining at least one of an accuracy metric, a precision metric, or a recall metric of the AI model.

8. The method of claim 1, wherein the first set of inputs comprises descriptive data of a media content item of the one or more media content items.

9. A system comprising:
a memory device; and
a processing device coupled to the memory device, the processing device to perform operations comprising:
identifying an artificial intelligence (AI) model trained to perform one or more tasks pertaining to one or more media content items of a platform;
performing, at a first point in time, a set of testing operations with respect to the identified AI model, wherein the set of testing operations is associated with testing a performance of an execution environment of the AI model and testing a quality of one or more outputs of the AI model based on a first set of inputs provided to the AI model at the first point in time;
determining a combined quality and performance score for the AI model that reflects the quality of the one or more outputs of the AI model during the performing of the set of testing operations and the performance of the execution environment of the AI model during the performing of the set of testing operations, wherein the performance of the execution environment of the AI model is based on at least one of a latency, a throughput, or a reliability of the execution environment of the AI model; and
sending, to the platform, a notification indicating the combined quality and performance score for the AI model.

10. The system of claim 9, wherein the operations further comprise:
performing, at a second point in time, a second set of testing operations with respect to the identified AI model, wherein the second set of testing operations is associated with testing the quality of the one or more outputs of the AI model and testing the performance of the execution environment of the AI model based on a second set of inputs provided to the AI model at the second point in time;
determining, based on the second set of testing operations, an updated combined quality and performance score for the AI model; and
sending, to the platform, a second notification indicating the updated combined quality and performance score for the AI model.

11. The system of claim 9, wherein the operations further comprise:
determining whether the combined quality and performance score for the AI model satisfies a criterion, wherein the notification comprises an indicator indicating whether the combined quality and performance score for the AI model satisfies the criterion, and wherein the criterion corresponds to the first set of inputs provided to the AI model at the first point in time.

12. The system of claim 11, wherein the operations further comprise:
responsive to determining that the combined quality and performance score for the AI model satisfies the criterion, causing execution of the AI model to pause.

13. The system of claim 9, wherein testing the performance of the execution environment of the AI model comprises:
determining a first number of media content items provided to the platform during a first time period ending at the first point in time;
determining a second number of media content items for which the AI model provided at least a subset of the one or more outputs; and
performing a comparison of the first number and the second number.

14. The system of claim 9, wherein testing the quality of the one or more outputs of the AI model comprises determining at least one of an accuracy metric, a precision metric, or a recall metric of the AI model.

15. A non-transitory computer readable storage medium comprising instructions for a server that, when executed by a processing device, cause the processing device to perform operations comprising:
identifying an artificial intelligence (AI) model trained to perform one or more tasks pertaining to one or more media content items of a platform;
performing, at a first point in time, a set of testing operations with respect to the identified AI model, wherein the set of testing operations is associated with testing a performance of an execution environment of the AI model and testing a quality of one or more outputs of the AI model based on a first set of inputs provided to the AI model at the first point in time;
determining a combined quality and performance score for the AI model that reflects the quality of the one or more outputs of the AI model during the performing of the set of testing operations and the performance of the execution environment of the AI model during the performing of the set of testing operations, wherein the performance of the execution environment of the AI model is based on at least one of a latency, a throughput, or a reliability of the execution environment of the AI model; and
sending, to the platform, a notification indicating the combined quality and performance score for the AI model.

16. The non-transitory computer readable storage medium of claim 15, further comprising:
performing, at a second point in time, a second set of testing operations with respect to the identified AI model, wherein the second set of testing operations is associated with testing the quality of the one or more outputs of the AI model and testing the performance of the execution environment of the AI model based on a second set of inputs provided to the AI model at the second point in time;
determining, based on the second set of testing operations, an updated combined quality and performance score for the AI model; and
sending, to the platform, a second notification indicating the updated combined quality and performance score for the AI model.

17. The non-transitory computer readable storage medium of claim 15, further comprising:
determining whether the combined quality and performance score for the AI model satisfies a criterion, wherein the notification comprises an indicator indicating whether the combined quality and performance score for the AI model satisfies the criterion, and wherein the criterion corresponds to the first set of inputs provided to the AI model at the first point in time.

18. The non-transitory computer readable storage medium of claim 17, further comprising:
responsive to determining that the combined quality and performance score for the AI model satisfies the criterion, causing execution of the AI model to pause.

19. The non-transitory computer readable storage medium of claim 15, wherein testing the performance of the execution environment of the AI model comprises:
determining a first number of media content items provided to the platform during a first time period ending at the first point in time;
determining a second number of media content items for which the AI model provided at least a subset of the one or more outputs; and
performing a comparison of the first number and the second number.

20. The non-transitory computer readable storage medium of claim 15, wherein testing the quality of the one or more outputs of the AI model comprises determining at least one of an accuracy metric, a precision metric, or a recall metric.
